(19) United States
(12) Patent Application Publication
(10) Pub. No.: US 2026/0290724 A1
(43) Pub. Date: Sep. 24, 2026

(54) SWITCHING DEVICE

(71) Applicant: L&T TECHNOLOGY SERVICES LIMITED, Chennai (IN)

(72) Inventor: SHREYANS SHETH, Mumbai (IN)

(21) Appl. No.: 19/306,294

(22) Filed: Aug. 21, 2025

(30) Foreign Application Priority Data
Mar. 20, 2025 (IN) 202541025241

(51) Int. Cl. H01H 19/14; H01H 19/04

(52) U.S. Cl. CPC H01H 19/14; H01H 19/04

(57) ABSTRACT

A switching device is disclosed. The device comprises a housing with an opening, within which a cylinder is positioned. An actuator is rotatably mounted to the cylinder and extends outward through the opening, coupled to an activating member for controlled operation. An input terminal, is mounted to the housing, receives signals from an external source. A conductive extension, radially extending from the actuator within the housing, establishes connectivity between the input terminal and the actuator. Further, a plurality of output terminals are mounted to the housing to facilitate connections with external devices. At least one conductive strip extends radially from the actuator within the housing, ensuring a selective connection between the actuator and at least one of the plurality of output terminals. The actuator, along with the activating member, enables selective switching between the input terminal and one or more of the plurality of output terminals.

### TECHNICAL FIELD

Present disclosure relates to a field of electrical switch device. More particularly, aspects of the present disclosure relate a switching device.

### BACKGROUND

A switching device is an essential component in modern testing and signal routing environments. The switching device is structured to control and direct electrical signals between multiple input and output channels, enabling efficient management of test configurations. Advanced switching solutions are integral to high-speed, multi-channel systems, ensuring precise, reliable, and repeatable signal transitions. Conventionally switching devices typically operate in a sequential manner, meaning each output transition occurs one after another rather than simultaneously. This functionality constraint results in increased response times, making real-time adjustments difficult and inefficient. In applications requiring multiple signal paths to be modified concurrently, this sequential approach in the switching device limits test efficiency and accuracy.

Furthermore, the conventional switching devices lack necessary synchronization capabilities required for high-speed, multi-channel testing environments. The inability to switch multiple outputs at the same time leads to inconsistencies in signal timing, impacting reliability and repeatability of test results. In industries where precise timing and coordination are critical, such as telecommunications, automotive, and aerospace, these shortcomings pose significant challenges. Another limitation of the conventional switch devices is scalability. As a number of required test points increases, managing a switching process becomes increasingly complex and inefficient.

Therefore, there exists a need to develop an improved switching device capable of executing multiple transitions simultaneously while maintaining reliability and repeatability. The present disclosure is directed to overcome one or more limitations stated above or any other limitations associated with the prior art. The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

In an embodiment, a switching device is disclosed. The switching device comprises a housing having an opening. A cylinder is positioned within the housing. An actuator is rotatably mounted over the cylinder and projecting outwards from the opening wherein the actuator is coupled to an activating member. Further, an input terminal is mounted to the housing and configured to receive an input from an external source. A conductive extension extends radially from the actuator and positioned within the housing and configured to connect the input terminal to the actuator. A plurality of output terminals are mounted to the housing for connection with at least one external apparatus. At least one conductive strip extends radially from the actuator and is positioned within the housing. The conductive strip is configured to connect at least one of the plurality of the output terminals to the actuator. The actuator and the activating member are adapted to selectively establish a connection between the input terminal and at least one of the plurality of output terminals.

In an embodiment, the activating member is integrally positioned within the actuator and configured to independently actuate between a pressed condition and a released condition.

In an embodiment, comprises a conductive disc is mounted at a bottom portion of the cylinder in operative connection to the activating member.

In an embodiment, the pressed condition is a condition where the activating member is pressed inward into the actuator from an initial position to a pressed position, causing the conductive disc to disconnect the input terminal from the plurality of output terminals and establish the connection between the input terminal and at least one of the plurality of output terminals, through the conductive extension, the actuator and the at least one conductive strip.

In an embodiment, the released condition is a condition where the activating member is pressed to return to the initial position from the pressed position, causing the conductive disc to connect the input terminal with each of the plurality of output terminals.

In an embodiment, the activating member is within the housing and operatively connected to the actuator to transition the actuator between a pressed state and a released state.

In an embodiment, the pressed state is a state where the actuator is pressed inward into the housing from an initial position to a pressed position, causing the conductive disc to disconnect the input terminal from the plurality of output terminals and establish the connection between the input terminal and at least one of the plurality of output terminals, through the conductive extension, the actuator and the at least one conductive strip.

In an embodiment, the released state is a state where the actuator is pressed to return to the initial position from the pressed position, causing the conductive disc to connect the input terminal with each of the plurality of output terminals.

In an embodiment, the device comprises a locking mechanism disposed around the activating member wherein the locking mechanism is configured to retain the actuator in at least one of the initial position or the pressed position and includes a biasing member to facilitate the transition of the actuator between the pressed state and the released state.

In an embodiment, the conductive disc is coupled to the activating member by the biasing member. The biasing member is adapted for biasing the conductive disc towards the input terminal and the plurality of output terminals to maintain secure connection.

In an embodiment, the actuator is configured to selectively establish connection between the input terminal with at least one of the plurality of output terminals through the conductive extension and the at least one conductive strip, based on a rotational position of the actuator.

In an embodiment, the input terminal and the plurality of output terminals are partially enclosed within the housing for connection with the input from the external source. The input terminal and the plurality of output terminals partially project outward from the housing for connection with the input from the external source, to at least one external apparatus.

In an embodiment, the device include a detent mechanism coupled to the actuator to provide tactile feedback during rotation of the actuator. In an embodiment, the conductive strip is integrally formed with or coupled to the actuator.

The present disclosure further discloses a method for selectively establishing an electrical connection in a switching device. The method comprises positioning an actuator rotatably over a cylinder within a housing such that the actuator is coupled to an activating member and projects outward from an opening of the housing. Further, method includes receiving an input signal at an input terminal mounted to the housing. Further, an electrical connection is established between the input terminal and at least one of the plurality of output terminal through a conductive extension extending radially from the actuator and at least one conductive strip positioned within the housing. The activating member is actuated independently between a pressed condition and a released condition. In the pressed condition, the activating member is pressed inwards into the actuator to transition a conductive disc coupled to the activating member by a biasing member, to disconnect the input terminal from the plurality of output terminals and establish a connection between the input terminal and at least one of the plurality of output terminal through the conductive extension, the actuator and the at least one conductive strip, based on rotational position of the actuator. In the released condition, the activating member is re-pressed returns to the initial position, wherein the biasing member biases the conductive disc towards the input terminal and the plurality of output terminals to maintain a secure connection.

A method for selectively establishing an electrical connection in a switching device is disclosed. The method comprises positioning an actuator rotatably over a cylinder within a housing. The actuator is coupled to an activating member disposed within the housing and operatively connected to transition the actuator between a pressed state and a released state. An input signal is received at an input terminal mounted to the housing. The actuator is rotating to a selected rotational position to selectively establish a connection between the input terminal and at least one of a plurality of output terminals through a conductive extension and at least one conductive strip positioned within the housing. The actuator is actuated to the pressed state by pressing inward into the housing from an initial position to a pressed position, causing a conductive disc to disconnect the input terminal from the plurality of output terminals and establish a connection between the input terminal and at least one of the plurality of output terminal through the conductive extension, the actuator, and the at least one conductive strip based on the rotational position of the actuator. Later, the actuator is returned to the released state by re-pressing to move from the pressed position return to the initial position, wherein the conductive disc reconnects the input terminal with the plurality of output terminals. At least one of the pressed states is retained and the released state using a locking mechanism disposed around the activating member wherein the locking mechanism retains the actuator in at least one of the initial position or the pressed position, and a biasing member biases the actuator between at least one of the pressed state and the released state.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a front perspective of a switching device, in accordance with an embodiment of the present disclosure;

FIG. 2a illustrates a top perspective view of the switching device in a pressed condition, in accordance with an embodiment of the present disclosure;

FIG. 2b illustrates a detailed perspective view of the switching device in the pressed condition, in accordance with an embodiment of the present disclosure;

FIG. 3 illustrates a perspective view of the switching device in a released condition, in accordance with an embodiment of the present disclosure;

FIG. 4 illustrates an embodiment of the switching device, in accordance with an embodiment of the present disclosure;

FIG. 5 illustrates a perspective view of a locking mechanism of the switching device of FIG. 4 in a pressed state, in accordance with an embodiment of the present disclosure;

FIG. 6 illustrates a perspective view of the locking mechanism of the switching device of FIG. 4 in a released state, in accordance with an embodiment of the present disclosure;

FIG. 7 illustrates a front perspective view of the switching device of FIG. 4 in a pressed state, in accordance with an embodiment of the present disclosure; and

FIG. 8 illustrates a front perspective view of the switching device of FIG. 4 in a released state, in accordance with an embodiment of the present disclosure;

FIG. 9 illustrates a top perspective view of the switching device in a pressed condition and connected to a selected external apparatus, in accordance with an embodiment of the present disclosure; and

FIG. 10 illustrates a top perspective view of the switching device in a released condition and connected to all external apparatus, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

It is to be noted that a person skilled in the art would be motivated from the present disclosure and modify construction of a switching device. However, such modifications should be construed within the scope of the present disclosure. Accordingly, the drawings show only those specific details that are pertinent to understand the embodiments of the present disclosure, so as not to obscure the disclosure with details that will be readily apparent to those of ordinary skill in the art having benefit of the description herein.

The terms “comprise,” “comprising,” or any other variations thereof used in the disclosure, are intended to cover a non-exclusive inclusion, such that a system and method that comprises a list of components does not include only those components but may include other components not expressly listed or inherent to such system, method, or assembly, or device. In other words, one or more elements in a system or device proceeded by “comprises... a” does not, without more constraints, preclude the existence of other elements or additional elements in the system or device.

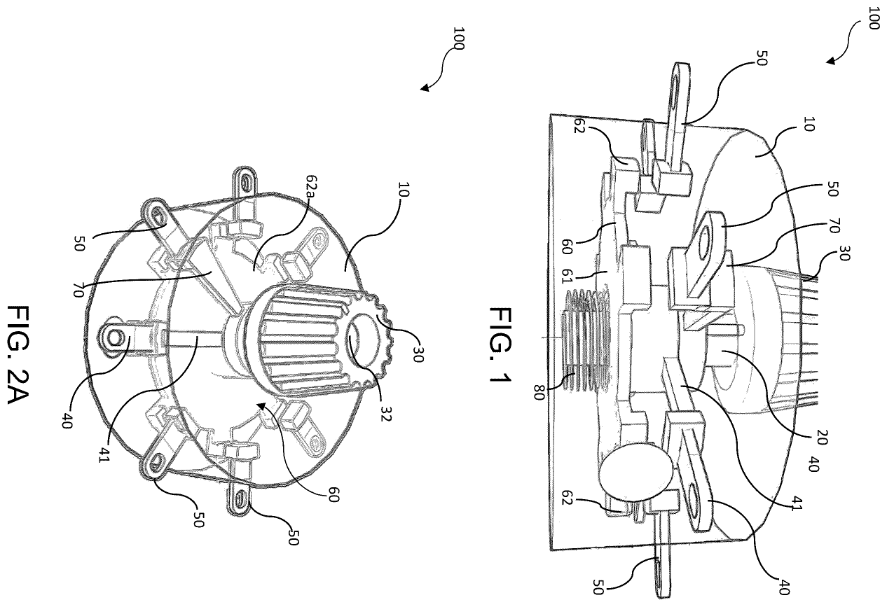

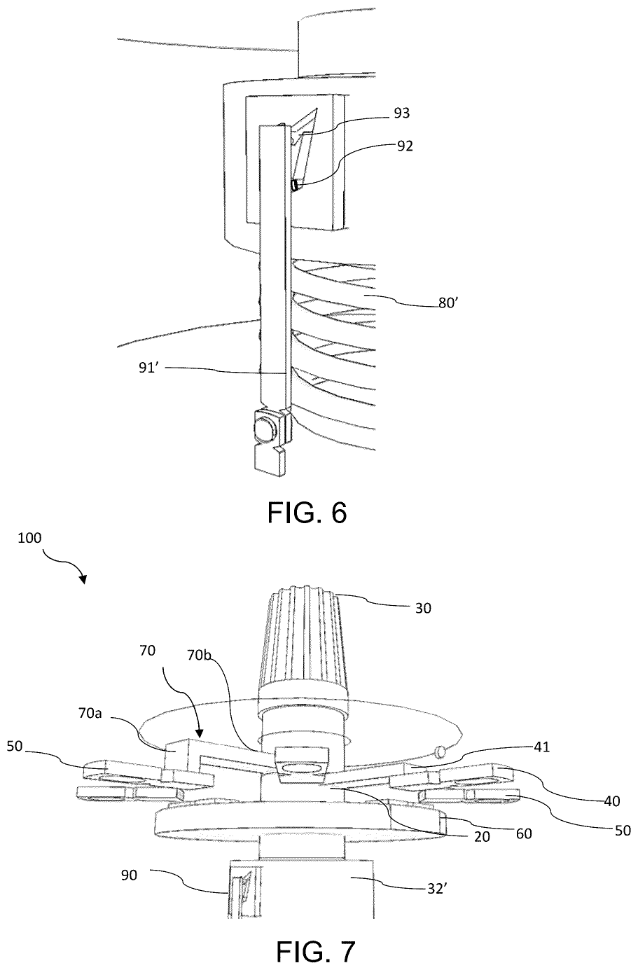

The following paragraphs describe the present disclosure with reference to FIG. 1 to FIG. 10. In the figures, the same element or elements which have similar functions are indicated by the same reference signs.

Referring to FIG. 1 to 10, which are exemplary embodiments of the present disclosure illustrating a switching device (100) [alternatively referred as the “device (100)”].

The following detailed description is merely exemplary in nature and is not intended to limit application and uses. Furthermore, there is no intention to be bound by any theory presented in the preceding background or summary or the following detailed description. It is to be understood that the disclosure may assume various alternative orientations and step sequences, except where expressly specified to the contrary. It is also to be understood that the specific devices or components illustrated in the attached drawings and described in the following specification are simply exemplary embodiments of the inventive concepts defined in the appended claims. Hence, specific dimensions or other physical characteristics relating to the embodiments that may be disclosed are not to be considered as limiting, unless the claims expressly state otherwise. Hereinafter, preferred embodiments of the present disclosure will be described referring to the accompanying drawings. While some specific terms of “upper,” “lower,” “below,” “above,” “right,” “left,” “rear” or “front” and other terms containing these specific terms and directed to a specific direction will be used, the purpose of usage of these terms or words is merely to facilitate understanding of the present invention referring to the drawings. Accordingly, it should be noted that the meanings of these terms or words should not improperly limit the technical scope of the present invention.

Also, it is to be understood that the phraseology and terminology used herein is for description and should not be regarded as limiting. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. It is to be understood that this disclosure is not limited to the specific devices, methods, applications, conditions, or parameters described and/or shown herein and that the terminology used herein is to describe particular embodiments by way of example and is not intended to be limiting of the claimed invention. Hereinafter in the following description, various embodiments will be described. For purposes of explanation, specific configurations and details are outlined to provide a thorough understanding of the embodiments. However, it will also be apparent to one skilled in the art that the embodiments may be practiced without the specific details. Furthermore, well-known features may be omitted or simplified in order not to obscure the embodiment being described.

Referring to FIGS. 1 to 3 in conjunction, which illustrates various views of a switching device (100) comprises a housing (10) defined with an opening [not specifically shown in Figures]. The housing (10) is a structural component of the switching device (100), configured for enclosing and supporting internal components of the device (100). Further, a cylinder (20) is positioned within the housing (10). This cylinder (20) is positioned and receivable in the opening of the housing (10), such that a portion of the cylinder (20) extends outwards from the housing (10). The housing (10) is structured to provide protection for the internal components while ensuring proper alignment and stability of the functional elements within the device (100). The cylinder (20) may be configured to move in reciprocating motion and may be rotatable within the housing (10). In an embodiment, a substantially central portion of the housing (10) is defined with the opening to receive the cylinder (20), wherein the cylinder (20) is structured to provide a central support for an actuator (30). The cylinder (20) is securely mounted within the housing (10) to maintain stability and prevent unwanted displacement, thereby contributing to a precise operation of the switching device (100).

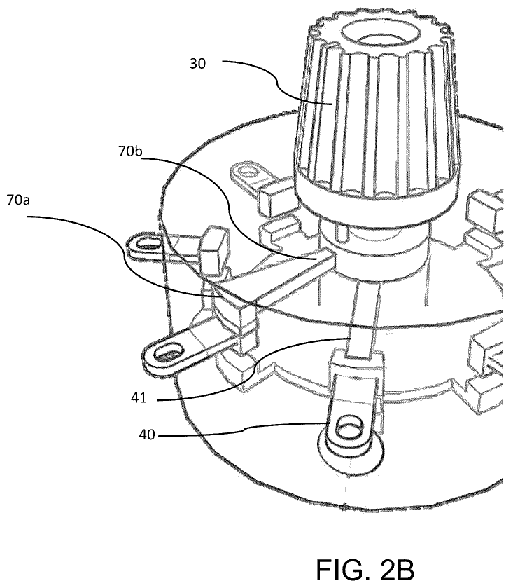

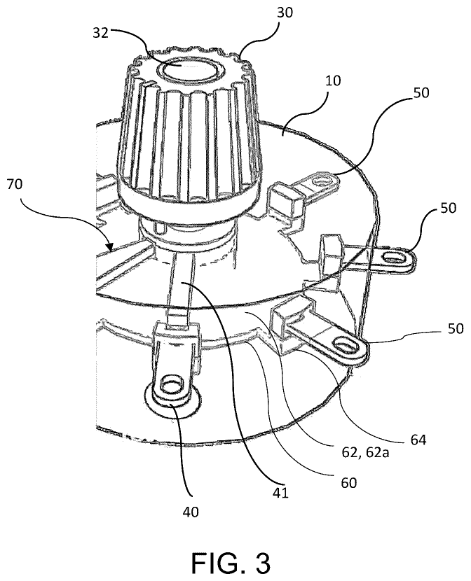

The device (100) comprises the actuator (30) rotatably mounted over the cylinder (20) and projects outward from the opening of the housing (10). The actuator (30) may be a primary user interface for operating the switching device (100). The actuator (30) is configured for the rotational movement about the housing (10). Further, the actuator (30) is coupled to an activating member (32, 32′) that facilitates the switching of the device in required configuration. In an embodiment of the switching device (100), the activating member (32) is integrally positioned within the actuator (30) and configured to independently actuate between a pressed condition and a released condition. In this configuration as illustrated in FIGS. 1 and 2a, the cylinder (20) may be structured to be a hollow cylinder, and a top portion of the cylinder (20) is configured to rotatably support the actuator (30). In an embodiment, the actuator (30) may be a rotatable knob having the activating member (32) integrally disposed within the knob and configured to be receivable and aligned within the hollow cylinder. The activating member (32) is configured to move linearly about the actuator (30) between the pressed condition and the released condition. Thus, in the pressed condition the activating member (32) is pressed inward into the actuator (30) from an initial position to a pressed position as best seen in FIG. 2a and FIG. 2b. Further, in the released condition the activating member (32) is pressed to return to the initial position from the pressed position as best seen in FIG. 3.

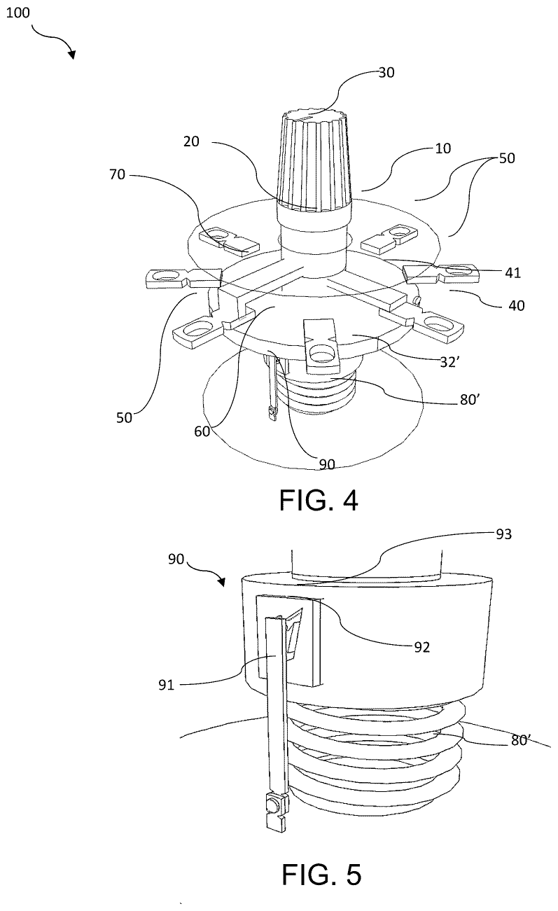

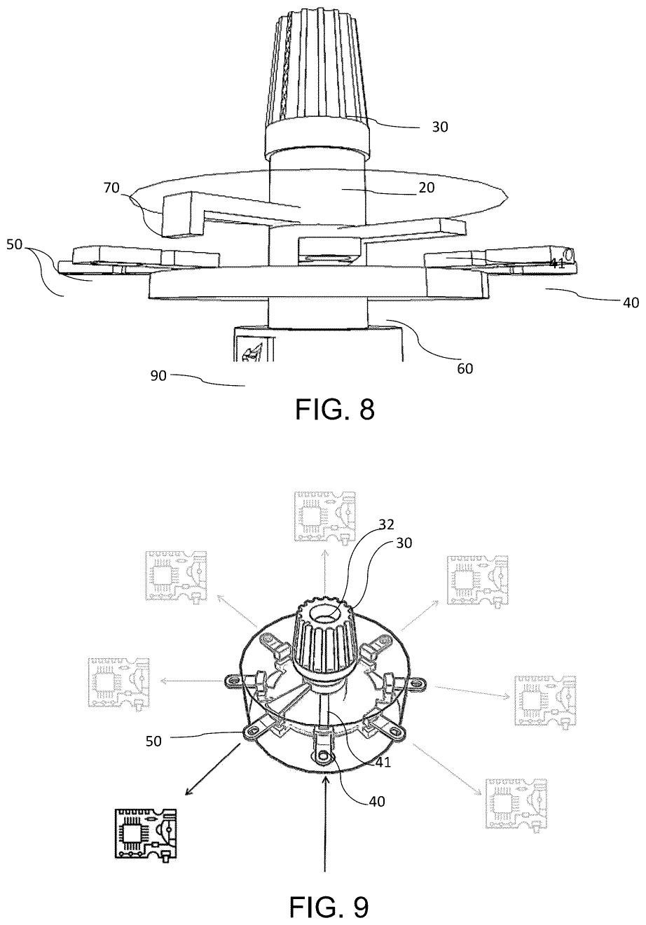

Referring to FIG. 4, which illustrates an embodiment of the switching device (100), wherein, the top portion of the cylinder (20) is configured to rotatably support the actuator (30). The activating member (32′) is operatively connected to the actuator (30) to transition the actuator (30) between a pressed state and a released state. In an embodiment, the actuator (30) configured as the rotatable knob is coupled to the activating member (32′). The activating member (32′) may be integrally connected with the actuator (30) and is within the housing (10). Thus, knob i.e., the actuator (30) is configured to move along with the activating member (32′) and cylinder (20) linearly or in a reciprocating movement about the housing (10) between the pressed state and the released state. Thus, in the pressed state the actuator (30) is pressed inward into the housing (10) from an initial position to a pressed position as best seen in FIG. 7. Further, in the released state the actuator (30) is pressed to return to the initial position from the pressed position as best seen in FIG. 8.

The device (100) of the present disclosure comprises an input terminal (40) mounted to the housing (10) and configured to receive an input from an external source. This input terminal (40) is an electrical interface component mounted onto the housing (10) of the switching device. The input terminal (40) may be structured to have a portion partially enclosed within the housing (10). Further, the input terminal (40) may extend away from the housing (10) to partially project outwards from the housing (10) for connection with the input from the external source. The input terminal (40) is mounted to a peripheral surface of the housing (10). The input terminal (40) provides a primary point for receiving electrical input from the external power source or a signal-generating circuit. The input terminal (40) is rigidly secured to the housing (10) to ensure mechanical stability and uninterrupted electrical connectivity. In an embodiment, the input terminal (40) is manufactured from a high-conductivity material. Further, the input terminal (40) may be provided with a protective coating or plating to prevent oxidation and improve durability.

Further, a conductive extension (41) extends radially from the actuator (30) and is positioned within the housing (10). This conductive extension (41) is configured to connect the input terminal (40) to the actuator (30). The conductive extension (41) is coupled to the actuator (30) such that it facilitates an electrical bridge between the input terminal (40) and the actuator (30), ensuring a controlled transfer of electrical current during operation of the device in the pressed condition. In an embodiment, the conductive extension (41) is mechanically and electrically integrated with the actuator (30). In the pressed condition, the conductive extension (41) may contact the input terminal (40), when the activating member (32,32′) is in the pressed position. In this condition, the conductive extension (41) performs as the electrical bridge between the input terminal (40) and the actuator (30). In released condition, the conductive extension (41) may move away and disengage with the input terminal (40), thus the electrical current is not transmitted through the conductive extension (41) as best seen in FIG. 8. The conductive extension (41) is precisely aligned within the housing (10). The conductive extension (41) is structured to maintain firm electrical contact while minimizing contact resistance and electrical arcing, which could degrade performance with continuous operation of the device (100).

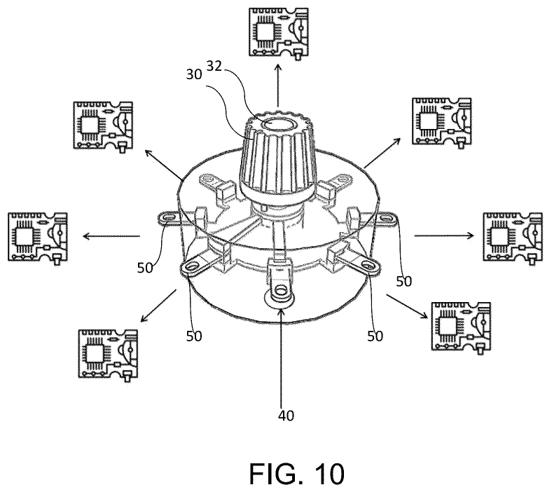

The device (100) comprises a plurality of output terminals (50) mounted to the housing (10). Each output terminal of the plurality output terminals (50) is mounted across the peripheral surface of the housing (10). The plurality of output terminals (50) is configured to provide connection with at least one external apparatus when received from the input terminal (40). The plurality of output terminals (50) are an array of conductive elements mounted on the housing (10), to interface with external electrical loads, circuits, or devices. In an embodiment selected plurality of output terminals (50) may be configured as connecting terminals for the electrical current received from the input terminal (40). This is based on the position of the actuator (30) and activation of the activating means (32). This configuration aids in determining which specific output terminal(s) may become active as per application requirement. The plurality of output terminals (50) extends outwards from the housing (10), enabling external connectivity with the at least one external apparatus. A portion of the plurality of output terminals (50) may be enclosed within the housing (10). In an embodiment, the plurality of output terminals (50) are arranged radially around the actuator (30), allowing for a rotary switching mechanism where at least one of the plurality of output terminal (50) may be selectively engaged based on rotation of the actuator (30). In an operative embodiment, all the plurality of output terminals (50) arranged radially around the actuator (30), establishes electrical connection with all the external apparatus connected with the plurality of output terminals (50) when electrical current is received from the input terminal (40) as seen in FIG. 9. In another operative embodiment, at least one electrical connection or selective electrical connection can be established between at least one external apparatus and at least one of the plurality of output terminals (50) when electrical current is received from the input terminal (40) as seen in FIG. 10. In an embodiment, the input terminal (40) and the plurality of output terminals (50) may be mounted to the housing (10) by at least one fastening means. The fastening means may be mechanical fasteners, thermally fusible material or by adhesive material.

The device (100) further includes at least one conductive strip (70) extending radially from the actuator (30). The conductive strip (70) is positioned within the housing (10) to connect at least one of the plurality of output terminals (50) to the actuator (30). In an embodiment, the conductive strip (70 may be connected to the cylinder (20) which is rotatable along with rotation of the actuator (30). Further, the actuator (30) is configured to selectively establish connection between the input terminal (40) with at least one of the plurality of output terminals (50) through the conductive extension (41) and the at least one conductive strip (70), based on a rotational position of the actuator (30). The conductive strip (70) is integrally formed with the actuator (30), or the conductive strip (70) may be coupled to the actuator (30).

Referring to FIG. 2b and FIG. 7, the conductive strip (70) is having a connecting end (70b) securely coupled to the actuator (30), ensuring stable electrical contact during operation. The conductive strip (70) extends longitudinally from the connection end (70b) and terminates at an operating end (70a), and is structured to extend along a predefined length to establish contact with a specific portion of the output terminal (50). This configuration ensures reliable electrical connectivity as the actuator (30) rotates, selectively engaging plurality of output terminals (50) based on the rotational position of the actuator (30). Therefore, this selective electrical connections with at least one of the plurality of output terminals (50) can be established by the conductive strip (70) during the pressed condition of the activating means (32,32′), when the electrical current is received from the input terminal (40) to pass through the conductive extension (41) and the actuator (30). The electrical connection between the input terminal (40) and the at least one of the plurality of output terminals (50) is established through the conductive strip (70), which extends radially from the actuator (30). As the actuator (30) rotates, the conductive strip (70) comes into contact with at least one of the plurality of output terminals (50), thereby directing the electrical current accordingly. In an embodiment, this configuration of the conductive strip (70) allows for multiple switching configurations, including single-pole multi-throw (SPMT) or rotary selector switch functions, depending on electrical circuit arrangement and application requirements.

The device (100) further comprises a conductive disc (60) mounted at a bottom portion of the cylinder (20). The conductive disc (60) is in operative connection to the activating member (32, 32′). In an embodiment, the conductive disc (30) may be coupled to the activating member (32, 32′) by a biasing member (80). The biasing member (80) is adapted for biasing the conductive disc (60) towards the input terminal (40) and the plurality of output terminals (50) to maintain secure connection. The biasing member (80) may be in an extended state and compressed state, wherein the biasing member (80) may retain in a compressed state when the activated means (32, 32′) in the pressed position. Alternatively, the biasing member (80) may be in an extended state when the activated means (32, 32′) is in an initial position condition. The conductive disc (60) is structured as a dynamic contact bridge, to establish electrical connection between the input terminal (40) and the plurality of output terminals (50) based on the operational position of the activating member (32) and the actuator (30).

In one of the structural embodiments as illustrated in FIGS. 1 to 3, the conductive disc (60) is defined with a body (62) and a plurality of projections (64) are disposed radially along a periphery of the body (62). The plurality of projections (64) extends upwardly from the body (62) and is adapted to align with the input terminal (40) and the plurality of output terminals (50). In another structural embodiment, as illustrated in FIG. 4, to 8, the conductive disc (60) may be structured to have a body extended to have predetermined surface area to align with the input terminal (40) and the plurality of output terminals (50). The device (100) of the present disclosure facilitates the actuator (30) and the activating member (32, 32′) to selectively establish a connection between the input terminal (40) and at least one of the plurality of output terminals (50) based on the position of the conductive disc. In an embodiment, the conductive disc (60) may be provided with an insulating coating to prevent any short circuit during operation of the device (100)

Referring to FIGS. 1 to 3 in conjunction with FIGS. 9 to 10, in one of the operative configurations of device (100) is explained further when the activating member (32) is integrally positioned within the actuator (30) and configured to independently actuate between the pressed condition and the released condition. The pressed condition as specifically seen in FIGS. 2a and 2b, is a condition where the activating member (32) is pressed inward into the actuator (30) from an initial position to a pressed position. This causes the conductive disc (60) to disconnect the input terminal from the plurality of output terminals (50). This establishes the connection between the input terminal (40) and at least one of the plurality of output terminals (50), through the conductive extension (41), the actuator and the at least one conductive strip (70).

More particularly, in the pressed condition, the activating member (32) is pushed inward into the actuator (30), transitioning from the initial position to the pressed position. This inward movement exerts force on the conductive disc (60), shifting away from the plurality of output terminals (50) and alternate electrical pathways. Further, the biasing member (80) applies a retaining force on the conductive disc (60), to maintain the pressed condition even after external pressure on the activating member (32) is removed. Thus, conductive disc (60), which maintains contact between the input terminal (40) and the plurality of output terminals (50), is forced away and disconnected from all the plurality of output terminals (50). Therefore, electrical connection being distributed to all the plurality of output terminals (50) is interrupted, and the electrical current from the input terminal (40) is redirected through the alternate electrical pathway. This alternate electrical pathway is provided by the conductive extension (41), radially extending from the actuator (30). The conductive extension (41) receives the electrical current from the input terminal (40) and transmits it through the actuator (30) and at least one conductive strip (70). Further in the pressed position of the activating means (32), the actuator (30) may rotate about its axis such that the at least one conductive strip (70) is configured to align with at least one of the plurality of output terminals (50). Thus, in the pressed condition, the conductive strip (70) ensures that the electrical connection is established between the input terminal (40) and one or more specific output terminals (50). Therefore, this allows controlled and selective activation of the external apparatus that is in contact with the one or more specific output terminals (50) as seen in FIG. 9.

Further, in the released condition of the activating member (32) as specifically seen in FIG. 3, there is a condition where the activating member (32) is pressed to return to the initial position from the pressed position, causing the conductive disc (60) to connect the input terminal (40) with each of the plurality of output terminals (50). The released condition is activated when the activating member (32) is pressed again, allowing the activating means (32) to return to the initial position. This movement is facilitated by the biasing member (80), which transitions from the compressed state back to the expanded state, thereby applying a restorative force to the conductive disc (60). As the conductive disc (60) repositions to move towards and re-engage with the plurality of the output terminals (50), electrical connection between the input terminal (40) and all the plurality of output terminals (50) is restored. In this released condition, of the switching device (100), the electrical current received from the input terminal (40) is transmitted and distributed to all the plurality of output terminals (50) simultaneously without any interruption or delay. This ensures that all connected external apparatus receives an uninterrupted electrical supply for activation, making the device (100) suitable for applications requiring continuous power distribution to multiple devices concurrently as seen in FIG. 10.

Referring to FIG. 4 to FIG. 8 in conjunction, an embodiment of the operative configurations of device (100) is explained further when the activating member (32′) is within the housing (10) and operatively connected to the actuator (30) to transition the actuator (30) between the pressed state and the released state. In this configuration of the device (100), the activating member (32′) may be operatively connected and functionally linked to the actuator (30), ensuring that movement of the actuator (30) determines the transition between the pressed state and the released state. The pressed state as illustrated in FIG. 4 and FIG. 7, is a state where the actuator (30) is pressed inward into the housing (10) from an initial position to a pressed position. This causes the conductive disc (60) to disconnect the input terminal (40) from the plurality of output terminals (50). This establishes the connection between the input terminal (40) and at least one of the plurality of output terminals (50), through the conductive extension (41), the actuator and the at least one conductive strip (70).

More particularly, as seen in FIG. 4 and FIG. 5, in the pressed state, the actuator (30) is pushed inwards into the housing (10) from the initial position. Thus the movement of the actuator (30) causes the activating member (32′), being embedded within the actuator (30), also to move inward to be in pressed position. As the actuator (30) transitions to the pressed position, this disengages the conductive disc (60) from the contact with the plurality of output terminals (50), effectively disconnecting the input terminal (40) from all the plurality of output terminals (50). Further, in the pressed position of the activating means (32′), the actuator (30) may rotate about its axis such that the least one conductive strip (70) is configured to align with at least one of the plurality of output terminals (50). Thus, in the pressed condition, the conductive strip (70) ensures that electrical connection is established between the input terminal (40) and one or more specific output terminals (50). Therefore, this allows controlled and selective activation of the external apparatus that is in contact with the one or more specific output terminals (50). Furthermore, the biasing member (80) positioned beneath the conductive disc (60), will be in the compressed state, storing potential energy. This compression of the biasing member (80) ensures that the actuator (30) to retain the pressed state unless external force is applied.

Additionally, a locking mechanism (90) is disposed around the activating member (32′). The locking mechanism (90) may comprise a shaft (91) pivotable connected to a base portion of the housing (10) at one end and other end of the shaft (91) is defined with a pin (92). The activating member (32′) may be defined with a cut profile (93) to receive the pin (92) and traversing of the pin (92) along the profile (93). Thus, the locking mechanism (90) is configured to retain the actuator (30) in at least one of the initial positions or in the pressed position. The cut profile (93) is a structurally designed recess or groove within the activating means (32′), allowing guided movement of the pin (92). This cut profile (93) may comprise predefined positions corresponding to the pressed state and released state of the actuator (30) and the activating means (32′), ensuring that the actuator (30) remains in place unless actively manipulated. The pin (92) is configured to slide within this cut profile (93), following a controlled path to transition between each of the pressed state and released state. Therefore, in the pressed state, as illustrated FIG. 5, the pin (92) is positioned at a bottom corner portion within the cut profile, engaging with a locking section. This engagement prevents accidental movement and maintains the actuator (30) and the activating means (32′) in the inward-pressed condition. The biasing member (80′) is also in the compressed state, storing potential energy, which will aid in returning the released state.

Further, as seen in FIG. 8, the released state is where the actuator (30) is pressed to return to the initial position from the pressed position, causing the conductive disc (60) to connect the input terminal (40) with each of the plurality of output terminals (50). The released state is achieved when the actuator (30) is pressed again, allowing the biasing member (80′) to expand and restore the actuator (30) and the activating member (32′) to its initial position. This action simultaneously repositions the activating member (32′) and facilitates the reconnection of the conductive disc (60) with the plurality of output terminals (50). The electrical current received from the input terminal (40) is transmitted and distributed to all output terminals (50) simultaneously without any interruption or delay. This ensures that all connected external apparatus receive an uninterrupted electrical supply for activation, making the device (100) suitable for applications requiring continuous power distribution to multiple devices concurrently.

Additionally, in the released state, the pin (92) moves upward within the cut profile (93), transitioning to a different predefined position. This pin (92 may traverse along the cut profile to be at engaged and retained within the locking section defined at an upper corner of the cut profile (93). The biasing member (80′) expands, exerting force to push the actuator back to the initial position. This movement ensures the electrical connection between the input terminal (40) and all output terminals (50) is established.

The present disclosure further discloses a method for selectively establishing an electrical connection in the switching device (100). In the pressed condition, the method involves actuating the activating member (32) by pressing inwards into the actuator (30), which is rotatably positioned over the cylinder (20) within the housing (10). This pressing causes the conductive disc (60) which is operatively connected to the activating member (32) and biased by the biasing member (80) to transition away from the initial position to pressed position. As a result, the electrical connection between the input terminal (40) and the plurality of output terminals (50) is disconnected. Instead, the electrical path is established, linking the input terminal (40) with at least one of the plurality of the output terminals (50). This connection is achieved through the conductive extension (41) extending radially from the actuator (30) and at least one conductive strip (70) positioned aligned with the selected output terminal i.e., at least one of the plurality of the output terminals (50) when the actuator (30) is rotated. The selection of the output terminals (50) is influenced by the rotational position of the actuator (30), ensuring that the desired electrical connection is made while preventing undesired contact with other terminals. Consequently, in the released condition, the method requires re-pressing the activating member (32) to transition the actuator (30) back to the initial position from the pressed position. Thus, the biasing member (80) expands from the compressed state, exerting a biasing force, on the conductive disc (60). This results in establishing the electrical connection between the input terminal (40) and all output terminals (50), ensuring continuity across the circuit. The biasing member (80) ensures that the conductive disc (60) maintains firm contact with the input and output terminals (40, 50), providing a secure and stable electrical connection. This actuation of the activating means (32) and the actuator (30) allows for selective and dynamic switching with reliability, preventing unintended disconnections.

In another embodiment, the method to selectively establishing the electrical connection in the switching device (100) is disclosed. The method comprises, positioning the actuator (30) rotatably over the cylinder (20) within the housing (10), where the actuator (30) is operatively connected to the activating member (32′). The actuator (30) is rotated to a selected rotational position, aligning the conductive extension (41) with at least one of the plurality of the output terminals (50) to define a potential electrical path. Upon pressing the actuator (30) inward into the housing (10) from the initial position to the pressed position, the activating member (32′) causes the conductive disc (60) to transition. This movement disconnects the input terminal (40) from the plurality of output terminals (50) while simultaneously establishing a connection between the input terminal (40) and at least one of the plurality of output terminals (50). The connection path is formed through the conductive extension (41), the actuator (30), and at least one conductive strip (70), ensuring the proper switching function based on the actuator's (30) position. During this state, the locking mechanism (90) retains the actuator (30) in the pressed position, preventing unintended movement. The biasing member (80′) is compressed in this state, exerting a force that prepares to restore the actuator to its released state when re-actuated. In the released state, the method involves re-pressing the actuator (30) to initiate the transition from the pressed position back to the initial position. Upon this pressing, the conductive disc (60) returns to the towards the output terminals (50), to establish the electrical connection between the input terminal (40) and the plurality of output terminals (50). Thus, the input terminal (40) remains in contact with all output terminals (50). The biasing member (80′) may expand, facilitating the movement of the actuator (30) and restoring the biasing member (80′) to the initial position. Additionally, the locking mechanism (90) retains the actuator in either the pressed or released position, depending on the desired operational state. This controlled transition between states ensures stable and reliable switching functionality, allowing for selective engagement of electrical paths while maintaining mechanical stability within the switching device (100).

In an embodiment, the switching device (100) may include a detent mechanism coupled to the actuator (30) to provide tactile feedback during the rotational movement. This detent mechanism ensures that the actuator (30) moves and locks into predefined rotational positions corresponding to specific output terminals (50), allowing precise selection and connection. The detent mechanism provides a user control and accuracy by providing a noticeable resistance and “click” sensation at each indexed position, preventing unintended rotations. Further, By integrating the detent mechanism, the device (100) facilitates consistent and stable electrical connections while improving operability and usability. This tactile feedback can be provided in applications requiring controlled switching between multiple output terminals and selected output terminal, thereby providing users to physically sense when the actuator (30) has reached a specific and precise rotational position, therefore reducing errors.

In an embodiment, the device (100) of the present disclosure having the actuator enables-controlled selection of output terminals (50) through both rotational positioning and pressing actions, ensuring reliable and dynamic switching.

In another embodiment, the device (100) of the present disclosure having the conductive disc (60) and conductive extension (41) ensure consistent electrical connectivity, minimizing a risk of loss of connectivity, short circuits, or unintended disconnections.

Moreover, a single board testing can be performed using the device (100) of the present disclosure, enabling efficient and streamlined testing without requiring additional switching components.

It is intended that the disclosure and examples be considered as exemplary only, with a true scope of disclosed embodiments being indicated by the following claims.

What is claimed is:

1. A switching device comprising:
a housing having an opening;
a cylinder positioned within the housing;
an actuator rotatably mounted over the cylinder and projecting outwards from the opening, wherein the actuator is coupled to an activating member;
an input terminal mounted to the housing and configured to receive an input from an external source;
a conductive extension extending radially from the actuator and positioned within the housing, configured to connect the input terminal to the actuator;
a plurality of output terminals mounted to the housing, for connection with at least one external apparatus; and
at least one conductive strip extending radially from the actuator and positioned within the housing, configured to connect at least one of the plurality of output terminals to the actuator,
wherein the actuator and the activating member are adapted to selectively establish a connection between the input terminal and at least one terminal of the plurality of output terminals.

2. The switching device of claim 1, wherein the activating member is integrally positioned within the actuator and configured to independently actuate between a pressed condition and a released condition.

3. The switching device of claim 2, comprising a conductive disc mounted at a bottom portion of the cylinder in operative connection to the activating member.

4. The switching device of claim 3, wherein
the pressed condition is a condition where the activating member is pressed inward into the actuator from an initial position to a pressed position, causing the conductive disc to disconnect the input terminal from the plurality of output terminals and establish the connection between the input terminal and at least one of the plurality of output terminals, through the conductive extension, the actuator and the at least one conductive strip, and
the released condition is a condition where the activating member is pressed to return to the initial position from the pressed position, causing the conductive disc to connect the input terminal with each of the plurality of output terminals.

5. The switching device of claim 1, wherein the activating member is within the housing and operatively connected to the actuator to transition the actuator between a pressed state and a released state.

6. The switching device of claim 5, wherein
the pressed state is a state where the actuator is pressed inward into the housing from an initial position to a pressed position, causing the conductive disc to disconnect the input terminal from the plurality of output terminals and establish the connection between the input terminal and at least one of the plurality of output terminals, through the conductive extension, the actuator and the at least one conductive strip, and
the released state is a state where the actuator is pressed to return to the initial position from the pressed position, causing the conductive disc to connect the input terminal with each of the plurality of output terminals.

7. The switching device of claim 5, comprising a locking mechanism disposed around the activating member, wherein the locking mechanism is configured to retain the actuator in at least one of the initial position or the pressed position, and includes a biasing member to facilitate the transition of the actuator between the pressed state and the released state.

8. The switching device of claim 3, wherein the conductive disc is coupled to the activating member by the biasing member, and wherein the biasing member is adapted for biasing the conductive disc towards the input terminal and the plurality of output terminals to maintain secure connection.

9. The switching device of claim 1, wherein the actuator is configured to selectively establish connection between the input terminal with at least one of the plurality of output terminals through the conductive extension and the at least one conductive strip, based on a rotational position of the actuator, and wherein the at least one conductive strip is integrally formed with or coupled to the actuator.

10. The switching device of claim 1, wherein the input terminal and the plurality of output terminals are partially enclosed within the housing for connection with the input from the external source, and wherein the input terminal and the plurality of output terminals partially project outward from the housing for connection with the input from the external source, to at least one external apparatus.

11. The switching device of claim 1, comprising a detent mechanism coupled to the actuator to provide tactile feedback during rotation of the actuator.

12. A method for selectively establishing an electrical connection in a switching device, the method comprising:
positioning an actuator rotatably over a cylinder within a housing, wherein the actuator is coupled to an activating member and projects outward from an opening of the housing;
receiving an input signal at an input terminal mounted to the housing;
establishing an electrical connection between the input terminal and at least one of the plurality of output terminals through a conductive extension extending radially from the actuator and at least one conductive strip positioned within the housing ;
actuating the activating member independently between a pressed condition and a released condition, wherein:
in the pressed condition, pressing the activating member inward into the actuator transitions a conductive disc, coupled to the activating member by a biasing member, to disconnect the input terminal from the plurality of output terminals and establish a connection between the input terminal and at least one of the plurality of output terminals through the conductive extension, the actuator, and the at least one conductive strip, based on rotational position of the actuator; and
in the released condition, re-pressing the activating member returns to the initial position, wherein the biasing member biases the conductive disc towards the input terminal and the plurality of output terminals to maintain a secure connection.

13. A method for selectively establishing an electrical connection in a switching device, the method comprising:
positioning an actuator rotatably over a cylinder within a housing, wherein the actuator is coupled to an activating member disposed within the housing and operatively connected to transition the actuator between a pressed state and a released state;
receiving an input signal at an input terminal mounted to the housing;
rotating the actuator to a selected rotational position to selectively establish a connection between the input terminal and at least one of the plurality of output terminals through a conductive extension and at least one conductive strip positioned within the housing;
actuating the actuator to the pressed state by pressing inward into the housing from an initial position to a pressed position, causing a conductive disc to disconnect the input terminal from the plurality of output terminals and establish a connection between the input terminal and at least one of the plurality of output terminals through the conductive extension, the actuator, and the at least one conductive strip, based on the rotational position of the actuator;
returning the actuator to the released state by re-pressing to move from the pressed position return to the initial position, wherein the conductive disc reconnects the input terminal with the plurality of output terminals; and
retaining at least one of the pressed state and the released state using a locking mechanism disposed around the activating member, wherein the locking mechanism retains the actuator in at least one of the initial position or the pressed position, and a biasing member biases the actuator between at least one of the pressed state and the released state.
